(19) United States
(12) Patent Application Publication
(10) Pub. No.: US 2017/0316653 A1
(43) Pub. Date: Nov. 2, 2017

(54) STRAIGHTS AND EIGHTS, ROULETTE SIDE GAME TRACKING METHOD AND APPARATUS

(71) Applicant: Aces Up Gaming Inc., Wheat Ridge, CO (US)

(72) Inventor: Tony Alexander Cranford, Morrison, C0 (US)

(21) Appl. No.: 15/498,767

(22) Filed: Apr. 27, 2017

Related U.S. Application Data
(60) Provisional application No. 62/391,373, filed on Apr. 27, 2016.

(51) Int. Cl. G07F 17/32; G07F 17/34

(52) U.S. Cl. CPC G07F 17/3288; G07F 17/34; G07F 17/3276; G07F 17/3248; G07F 17/3258; G07F 17/3255; G07F 17/3269

(57) ABSTRACT

Straights and eights is a Roulette Side Game including a Tracking Method and apparatus. Wagers and payouts in physical items are provided for, which may be electronic, currency or virtual currency that are validated, and, if accepted, establish credit for game play and are likewise utilized for payout. A player with approved credit wagers on multiple consecutive spins on a live table, electronic table or virtual roulette game to win predetermined odds. The tracking apparatus comprises a sensor for reading a number such as an 8 roulette spin value where the spin of a roulette wheel and a ball, the ball spinning in the opposite direction than the wheel, lands in a pocket, a clock for determining when a bet may be placed in the side game and when no further bets are allowed, further sensors for determining what bets have been placed either electronically or manually and a controller for determining if a player deserves a payout either by the ball landing on two consecutive numbers, three consecutive numbers (a straight) or at least two or three of 8, 18 and 28, spin values comprising eights.

This application claims the right of priority to U.S. Provisional Patent Application Ser. No. 62/391,373 filed Apr. 27, 2016 entitled “Straights & 8's of the same inventor, incorporated by reference as to its entire subject matter.

### BACKGROUND OF THE INVENTION

### 1. Field of the Invention

The present invention has to do with, and relates to, the general field of casino gaming, more particularly, to the table play of games of chance, including games in the genre of roulette, and the present invention is, likewise, within that genre. The game that is the subject of this patent application may also be obtained in some or other form of electronic, computer play, commonly called virtual or electronic video roulette, or played on a telecommunications device or computer via the world-wide web as a video game player. And so the present game in electronic form is also subsumed by, under, and within the scope of this application.

### Background

The present invention and patent application concern advances in the science of game design, to wit: aspects of a side game to roulette in combination with aspects of poker and the presence of a particular number such as 8 in its forms: 8, 18 and 28. This invention in its embodiments are new, and unique, and original to the inventor. These various embodiments of the invention are perceived to offer unique features that are (1) both exciting and attractive to players of table, virtual world and video gaming apparatus, and (2) profitable for a gaming establishment and casino operators, and, at the same time, address and resolve the shortcomings of other casino roulette and related games played at tables or played on electronic apparatus. Of course, the present game may be played for recreational and other purposes besides any gambling purpose and so may be fun and recreational for players to play. Players, such as would play a conventional video game, may play for scores and, by the score, win the opportunity to play the game again and again or accumulate some form of virtual monetary advantage or determine how much the player may lose.

Roulette is one of the most popular games on the planet. Poker includes the concept of a “straight” which is the feat of obtaining five cards in order. The concept of winning based on a number of consecutive spins which includes a specific number such as 8 is not believed to be known in the art. The integer may be any integer between 1 and 9, not necessarily 8. The example of 8, 18 and 28 may be just as easily be 6, 16 and 26.

With specific regard to roulette—being one of the oldest and most popular games in the United States—this game has an established gambling aspect to it that allows a player to wager that he or she may bet on a known board where, typically, there are 36 numbers and, in Europe, one 0 at the top or, in the United States, both a 0 and a 00.

In that the player, as mentioned above, may be playing against the dealer or the house, if not also against other players at a table, both, or against a machine computer processor logic generated spin of the wheel and opposite spin of the ball, all possibilities thereof are within the scope of this invention. The player is actually playing to win typically by picking the number where the ball, since the wheel is tilted, loses momentum and falls into a particular pocket of the wheel, for example, referring to FIG. 1, a pocket numbered between 1 and 36 or a 0 or 00 pocket in the United States or just a 0 pocket in Europe. So, in order to evaluate the spin value of a given spin of the roulette wheel, there is a known reader circuit that may read via electromagnetic or other method where a ball has landed. It is not believed known to evaluate consecutive spins to determine if a player loses their bet or receives value in the form of a payout, award, jackpot, bonus, and/or anything else of value such as a score and by the score an opportunity to play the game again provided for by the rules of the play, all of the same subject to being the same and or different, depending upon the venues of play. Also, depending upon the design application of the game, any and all forms of a winning series of consecutive spins can be rewarded in any manner, or scale, or multiplier of any and all wagers or bets placed by the player on his or her hand or hands, and/or may be paid in accordance with a posted table card (California roulette) or pay table stored in machine memory wherein there may be enumerated winning consecutive spins and winning consecutive spin values, per any applicable pay table, based upon the number or value of chips, coins, tokens, tickets or credits (money), in the usual course, relative to the amount of the bet, wagered by the player.

For games played for money, for example, at a gaming table or by machine, such as the present Straights and Eights game played at a machine or casino gaming table, inventory manager-chip kiosks are known, for example, from U. S. Published Patent Application 2007/0060307, whereby chips representing currency may be dispensed in response to receipt of currency, credit card, debit card, bank account transmittal and the like. The kiosk may comprise, for example, a screen display, a touch pad or keypad data input, a chip reader, a ticket validator, an automatic teller capability for credit or debit and connect to the internet, Ethernet, or to various communication devices, electronic or optical to provide casino items of monetary value for play and items of monetary value for payout. The dispenser may stack chips (or other physical items as described below) on receipt and dispense the chips to a user or a single ticket having monetary value. Near field communication (NFC) transaction terminals may soon be or are already available to accept chips, tokens, tickets, credit and debit cards, and the like representing money electronically stored in mobile intelligent devices. The kiosk may use ATM protocols as well as NFC to receive or dispense physical items as defined below. Apple Pay and Google Wallet are examples of apps on cell phones that are ever improving NFC apps for intelligent phones. One communicates with a casino wager or payout device including a slot machine and can play electronically via credit, debit transactions through stored credit cards. Other devices known in the art include CashIO ticket redemption kiosks, tickets at table games (TITA) for ticket redemption and issuance at table games, for example, available from Apogee Electronic Services Inc., micro card redemption and charging devices and management software for managing such kiosks and devices. Another known provider of payment processing, cash handling and cash management services for casinos is NRT Technology Corp. of Ontario, Canada which uses the brands QuickJack, QuickTouch kiosk and QuickTable cash management. Cruise ships offer credit card/debit card storage and electronic play at cruise ship casinos. While some casinos operate on a strict cash basis, others prefer casino tokens, gaming chips, checks or cheques or tickets. Physical item, as used in the specification and claims, may be defined as a validated token, chip, check, ticket, electronic, stored credit/debit card or other casino accepted form of payment or payout having monetary value in both physical and electronic form as dispensed or received, for example, via near field communication between an equipped intelligent mobile device and a so-equipped transaction terminal, radio frequency communication, via the internet, via an Ethernet or hand delivery or validated receipt. One physical item as defined typically has a monetary value of, for example, one dollar US but may have a similar value in another currency such as one Euro (Europe) or one pound (the United Kingdom) or any known currency. Moreover, a payout may be in the form of a ticket of a value of fractional currency such as a payout from a conventional slot machine, for example, in quarter dollar US amounts and so fractional physical items as defined exist.

Also, a casino game may be simply played for fun. For example, a known smart telephone or small pad computer provides a keyboard with sufficient numerical, functional and alphabetic keys and typically a touch-screen to permit a player at a remote terminal to play a game for fun with a remote machine special-purpose computer. The game may run as an application on the device after downloading from a server as is known in the art.

In all of the above regarding this invention, its scope, likewise includes game play, table lay out or electronic interface, whereby the player may play two or more spins in the same game, without limitation in either a live, electronic or virtual form of play. Each spin so played may be subject to wagering in physical items as defined above and scoring and score accumulation, as described above and further herein.

Further to the above, upon completion of any spin or spins played, in table, virtual or electronic apparatus play of the game subject to this invention, any and all payouts, awards, jackpots, bonuses, and the like, may be paid in physical items as defined above or just be fun to the player and/or to the player and others in any sort of a community pay out or community pot (such as a virtual or imaginary pot where players may play straights and eights as a team), and the same is also subject to and included within the scope of this invention.

For clarity, it should be remarked that table games as referenced herein are usually played on ‘felt’, run by a live croupier, with a live player or players at the table which may number six or eight or more. Electronic video roulette may be today played on machines, virtual games on a smart telecommunications device or special game apparatus. Conventional electronic roulette may involve a typically metal or other solid cabinet and a video display terminal (VDT screen), usually a touch screen input device, and or deck of buttons (key board) to actuate play, and, within the terminal, a special purpose microprocessor of some sort that operates the varied features of the machine, from play to record keeping in memory, and the like. In a virtual sense, a player may play Straights and Eights at the same time as playing electronic roulettte using an electronic communications device with a remote machine.

In the usual course of play, a player inputs his or her wager, for example, in one or more physical items, and initiates play, whereupon a specially program microprocessor following rules of play selects at random from stored memory a digital representation of a spin that become the player's first spin value and may be displayed on an output device such as a display or, if table play, three consecutive winning spins may be shown, for example, on tracking board per FIG. 1 showing consecutive spins: 8, 18 and 28. This computer memory normally represents and includes each of the consecutive spins of a roulette wheel and a controller may determine if the consecutive spins represent a loss of a bet or a win in physical items. If a known reading circuit is available, a given spin may be displayed on the VDT of a machine or a telecommunications device to the player. The present invention intends to and may include any future use of a robotic or some new form of electronic form of what is now known as table play such as play on a hand held telecommunications device.

For historical perspective, the most popular form of roulette dates to the 1800's. In 1796, two pockets of the roulette wheel were reserved for the house or the bank which provides known roulette its “sole mathematical advantage.” Red and black have become the colors of the numbers one through thirty-six and green has become the standard color for the single 0 in Europe and the 0 and 00 in the United States (the two additional pockets). As can be readily discerned from the above discussion, all casino games, and, in fact, even Bingo, Lotto, blackjack, baccarat and Keno, depend upon numbers or cards. And, as has been repeatedly mentioned, in roulette, the spin value and whether a player has won or lost heretofore has been from but one single spin of the wheel and spin value (except blackjack and baccarat). The present invention introduces the concept of consecutive spin values forming a straight and eights in consecutive spins.

Many forms of roulette could be described and cited herein. However, it would be redundant, the point having been already made, to wit: roulette per se, as a game both of both chance and skill, is defined by and dependent upon a single spin, being a spin of a roulette wheel and the opposite spin of a ball where the ball lands on a number, for example, 0 or 00 or any number from one through thirty-six.

A problem with casino roulette and electronic roulette: all pay-outs are limited to one spin and the maximum amount that can be won in physical items or score is very limited, for example, to 35 to 1 odds for picking a number spin value correctly.

Simply put, there are no large jackpots or scores possible in the play of roulette, and, at the same time, the win frequency is not high in comparison to other casino games, and in the play of roulette per se, there is a plethora of common low pay/even money pay winning spins (such as red/black or odd/even) and, at the same time, no higher paying, winning spins, all of this being a function of roulette as normally played.

It is one object of the present invention to resolve the aforesaid and related shortcomings in the play of roulette and to combine exciting scoring aspects of straights and eights into a single game by and with the game of roulette that is the subject of this invention to increase the pay-outs and the excitement of a side game.

### SUMMARY OF THE INVENTION

The present invention extends, expands, and teaches new, and gambler-attractive, fun player attractive variant embodiments of a new game method and apparatus and computer program product for the play of any sort of table, virtual or robotic table game with table or electronic roulette aspects which incorporate poker aspects, a straight and multiple spins of numbers having eights (or other single integer) aspects. This contemplates a new game method for the play of the game, a new configuration of table on which a Straights and Eights game is played and a new machine or computer program product playable on a special purpose computer server or hand-held terminal but with the same typical roulette wheel (electronic or table), and makes provision for 0 in Europe and 0 and 00 in the US depending on choice of game rules.

As has already been mentioned in the above, the game that is the subject of this invention can be played in live table, robotic table, virtual or electronic configuration, between a croupier or special purpose machine and a single or multiple players, all competing with the wheel or the croupier or machine per se, according to the rules of the same (or played against the machine as a virtual house or dealer). In another configuration, the same game can be played, under the same or different rules, between any number of players, at the same table, and or at some sort of electronic virtual table, local or wide area via telecommunications; (this latter point applies to any and all forms of this game played in any electronic configuration) whereby the players may compete against each other in an attempt to win the pay outs, awards, jackpots, or scores in play with an award being defined as that pool of credits bet/value bet by the participating players, taken all together, and available for award in physical item(s) as defined above or for just plain fun of the game to the designated winner of consecutive spins played which may, for example, result in a game score and a number of free plays depending on the score (as in a conventional pinball machine form of play). The minimum number of consecutive spin values for a win may be two such as a “straight” of 20, 21 or two out of three such as: 8, 20, 18.

The present invention of the Straights and Eights game and associated apparatus, exemplary table configuration and the like will be discussed with reference to the drawings, a brief description of which follows.

### BRIEF DESCRIPTION OF THE DRAWINGS

FIG. 1 is a drawing of a typical exemplary table configuration for a roulette side game of Straights and Eights further showing the “eights” game concepts of a wager on three consecutive spin values of 8, 18 and 28.

FIG. 2A is a drawing of exemplary awards (Pays to 1), house edge, house return, and hit frequency when there is a single 0 as in European roulette; FIG. 2B is a drawing of exemplary awards (Pays to 1), house edge, house return and hit frequency when there are a 0 and a 00 or double zero pocket(s) on the roulette wheel.

FIG. 3 is an example of a block schematic diagram of exemplary gaming apparatus for playing Straights and Eights consisting of a processor, memory, communications device, a real time clock and input and output devices including specialized sensors for sensing the spin values, the placement of a dolly stopping a player from betting and for sensing of wagers by players on straights and eights.

### DETAILED DESCRIPTION

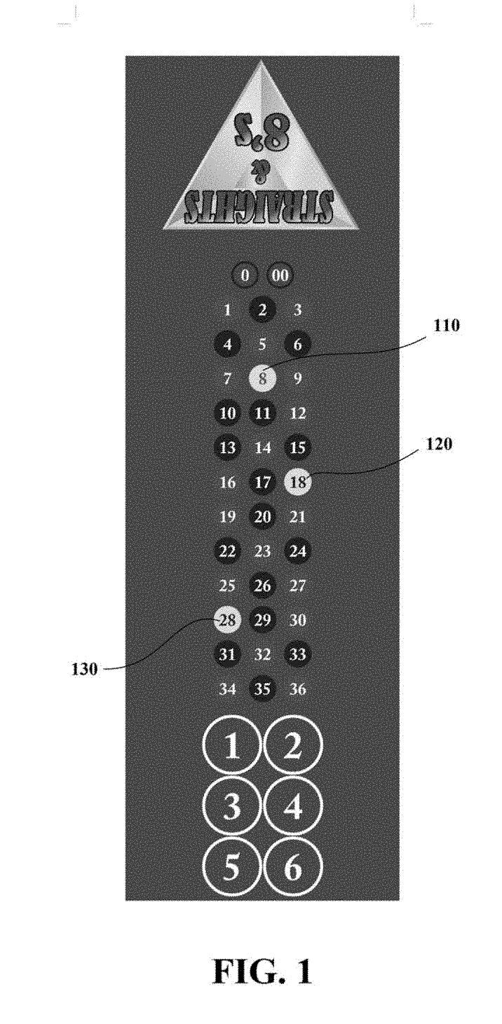

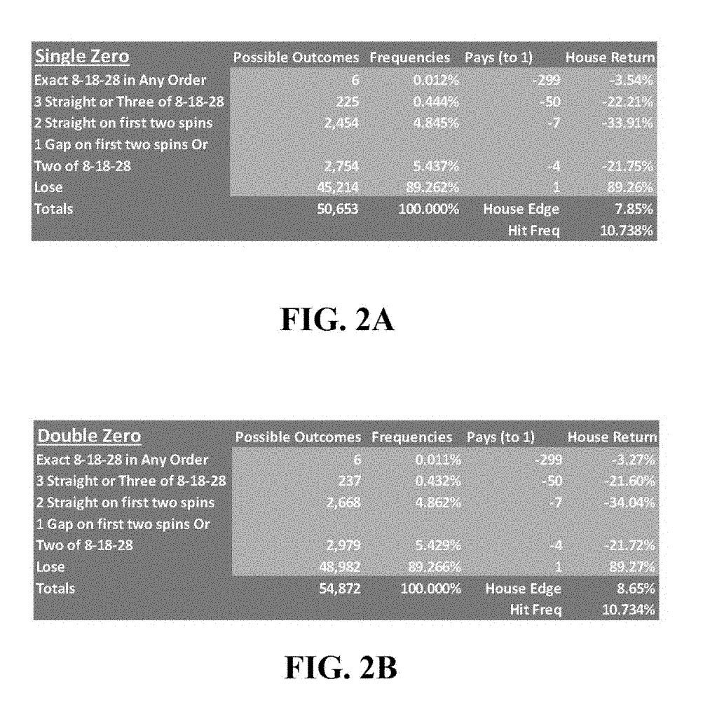

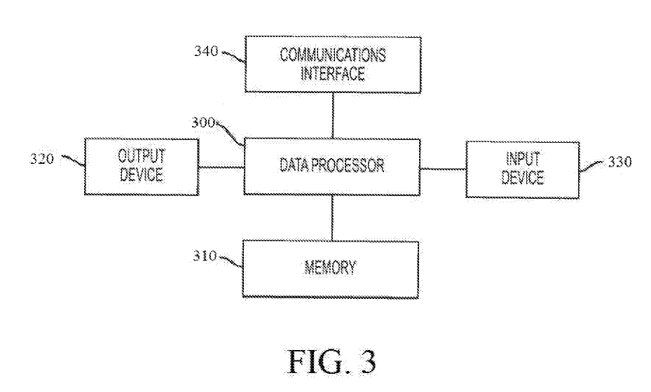

Straights and Eights, a side game to roulette, will now be discussed with reference to FIGS. 1-3. In order to play the game, each and all players, in whatever format the game is being played, may be required to place a wager, being a ‘place bet’ on the consecutive spin values to be played. This place bet may be a virtual value entered via a keyboard of an electronic device. An example board configuration which may be a felt table top or electronic board or device display is shown in FIG. 1. In FIG. 1, for each player, there may be a betting spot dedicated to them individually (six spots shown) having passed a credit check or provided sufficient funds and physical items as defined above, for example, via a kiosk or electronically via a communications interface per FIG. 3. An example of consecutive spins is shown comprising eight, 110, eighteen, 120 and 28, 130. Referring to FIG. 2, if the side game comprises three consecutive spin values of eight, eighteen and twenty-eight in order, the house will pay practically 300 to 1 which is a considerable improvement in player possible winnings on a single physical item such as one dollar over the thirty-five to one odds of picking a number in one embodiment of roulette.

A so-called place bet is made at the commencement of play of roulette by a player before any spins of a roulette wheel. The place bet is the first bet of a player and may be lost if, for example, the wager is on 8, 18 and 28 in order and a roulette ball falls into a 20 pocket after the player wins the first spin value and the ball falls in an 8 pocket of the wheel. As introduced above, straights and eights is a side wager using a series of consecutive roulette spins. The place bet wins when following the placement of a bet, for example: 1) the first two spins result in two numbers that are consecutive or separated by one number sequentially (the straight) and 2) the first two spins are any of 8, 18 and 28. The place bet wins at higher odds if the third spin completes a three number straight, for example, 20, 21 and 22 or the sequence 8, 18 and 28 in any order. If 8, 18 and 28 appear in three consecutive spins, the wager on this event occurring results in the highest payout at approximately 300 to 1.

In the game that is the subject of this invention, there are rules in straights and eights as there are in the main game of roulette. Straights and eights is played using a single zero (Europe) or a double zero (US) roulette wheel mounted on a table or a virtual wheel. For the purpose of the wheel sequence, the numbers one through thirty-six and the single and double zeroes do not count in straights or gaps between spin values such as eighteen and twenty cause a gap (nineteen).

Straight pay-outs will be discussed first. For example, there may be a one number gap as follows. If the first two spins are both greater than zero and result in at least two numbers that are separated by one number in any order, the player wins 4 to 1. An example, might be 18 and 20. An eights bonus works as follows: If the first two spins result in any two numbers ending with the number 8 (8, 18 and 28), the player also wins 4 to 1.

A two number straight may win a payout. If the first two spin values are both greater than zero and result in two consecutive numbers in any order, such as 19, 18, the player wins the two number straight wager at seven to one physical items such as seven dollars for a one dollar wager.

A three number straight wins an even greater number of physical items. If the bet or wager qualifies for a one number gap or a two number straight and the third spin either fills the gap (as in 18, 20 with a 19) or completes the three number straight, the wager will result in a higher payout than 35 to 1 in ordinary roulette or fifty to one, fifty physical items such as dollars for a one dollar wager. Also, as explained above, an extra bet may be permitted of a monetary value in physical items, outside the place bet, equal to a percentage of the place bet allocated. For example, a player takes 10 off his place bet (if it is still alive) and bets on the next spin and adds 10 as an extra bet but may only win based on 10 of the place bet and a reduced percentage such as 50% of his extra bet.

The play of the game that is the subject of this invention also provides for other bets in physical items as defined above at the outset of each consecutive spin which as will be described must be sensed and stored in memory at least for three spin values if the player is still alive and has not lost in the side game, for example, by consecutive spins of values 6 and 21 (there is no straight and no eights) so the wager is lost. There is an 8-18-28 top prize when if the first three spin values result in one of each of eight, eighteen and twenty-eight, in any order (for example, 18, 8 and 28) the player wins the top prize of three hundred to one (299 to 1). Each bet placed between spins of the roulette wheel or virtual wheel is eligible for only the highest payoff.

Clearly, extensions to the side game may be easily considered as well as other embodiments. For example, a four spin value straight or even a five spin value straight are conceivable where the number of gap numbers are increased. In an example of a four spin value straight, the first spin value may be 7 and the next spin value may be 10 leaving 8 and 9 as gap numbers that have not come up yet after just two spins of the roulette wheel or virtual wheel. If 8 and 9 gap numbers are actually filled, then, the player may win even greater amounts than 300 to 1 physical item. The logic applies for a five number straight as well and the straights part of the game of straights and eights can win if five consecutive spin values are reached can mean an even larger payout than a four number straight.

FIG. 2A is a drawing of exemplary awards (Pays to 1), house edge, house return, and hit frequency among other values in the side game of eights. FIG. 2A particularly deals with when there is a single 0 as in European roulette. FIG. 2B is a drawing of exemplary awards (Pays to 1), house edge, house return and hit frequency among other values when there are a 0 and a 00 or double zero pocket(s) on the roulette wheel. In the column of possible outcomes in the side game of eights, note that the number of possible outcomes increases from 225 to 237 in the event of a three straight or three of 8, 18 and 28. The frequencies goes down between Europe in FIG. 2A and the United States in FIG. 2B, the payout remains the same and the house return goes from 22.21% down to 21.60%. Other values can be read from the tables.

House edge warrants an explanation. House edge is also known as house average or house advantage and is the amount a player loses relative for any wager or bet in physical items made, on average. For example, if a player bets on a single number in the regular US (American) roulette game, there is a probability of one in thirty-eight (thirty-six numbers plus zero and double zero) that the player wins thirty-five times their wager in physical items and a 37/38 chance that the player loses the wager. The expected value or house edge is calculated as:

−1×37/38+35×1/38=−0.0526 (a 5.26% house edge).

There is in addition to the above, other aspects of the play of the game, in various configurations, that can include, for example, awards or pay outs, monetary or otherwise, or instance, free plays in virtual or machine gaming, and the like, for any sort of winner or loser, including even payouts for a sequence of 0 and 00 in an exemplary embodiment of Straights and Eights permitting such a sequence of these two consecutive spin values. Normally, 0 and 00 represent a losing bet for the player of roulette in the United States but may be rewarded in the side game if game rules permit.

FIG. 3 is an exemplary block schematic diagram of Straights and Eights apparatus or a system for permitting play of Straights and Eights, providing odds calculations, if necessary, accepting/receiving inputs such as wagers of individual qualified players who may be given a unique identification digital code and the like in physical items as defined above and outputting displays of the side game called Straights and Eights along with roulette or virtual roulette, making pay-offs in either the side game or roulette in physical items and providing other outputs and accepting croupier commands and inputs for selecting two consecutive spins up to three consecutive spin values (or more. Element 300 may be a data processor programmed for the specific purpose of evaluating status of each player after each consecutive spin value is determined or may comprise a programmed array or special application specific integrated circuit specially programmed in accordance with known roulette games and/or further providing the straights and eights side game adapted for play as a video roulette or virtual hand-held telecommunications game. The system may be implemented in any form such as a personal computer, personal data assistant, intelligent wireless mobile telephone, tablet computer or other device programmed for receiving, for example, side game wagers and memory for storing consecutive spins to determine either a win has occurred, for example, by filling gaps or otherwise in further consecutive spins as long as the player wager is not lose. Processor 300 is coupled to memory 310 for storing a computer implemented method of operation and rules of play in the form of computer-implemented instructions or sequences of computer code of the auxiliary Straights and Eights game per FIGS. 1-2 and descriptions of game play. Processor 300 may utilize known artificial intelligence methods of applying the game rules to make decisions such as whether the first and second consecutive spins result in a player pay-out because of straights or eights winners appearing in the two consecutive spins. The processor may be programmed to play roulette either US or European or California versions. Memory 310 may contain, for example, short term memory of wagers made, spin values (for example, up to five consecutive spins in a high wager game), and game forms selected and the like and long term memory for computer programs, downloads of same and the like. Memory 310 may also receive and store calculated pay-offs received from processor 300 or via a query via communications interface 340. Communications interface 440 may be equipped with GPS and/or with automatic number identification and/or with near field communication of physical items. The system may thus determine if a player terminal is within a region where gambling and wagering is permitted, or the game is played for, for example, fun or for game play credits or a score as well as with physical items. The calculated pay-offs offered, play credits, scores, spin values resulting in a player win and the like may be stored to determine the value of house winnings over time. Game displays may be output via a display 320 (not shown) of output device 320 which may print out tickets, credits, chips, checks, tokens and the like, any physical item payout, for example, automatically. Output device 320 may be utilized in Straights and Eights (or roulette if processor 300 is programmed to play both roulette and the side game, to make pay-outs to players in physical items via a selected manner of receipt as described above into the player's several accounts, if permitted. (More than one player may play at a given machine or telecommunications device, for example, equipped with near field transaction communication). Input device 330 may be a touch-screen display for accepting/receiving commands from a player or a croupier such as wagers, the consecutive spin values, the croupier's placing of a marker or other action that may be sensed by an input device and stored for later evaluation, a touch screen or keys or positions per FIG. 1 or may receive cash or credits or other inputs such as clear wager in the form, for example, of physical items as defined above or spin time of day to trigger a betting interval and cut-off when signaled by the croupier or a predetermined time interval for betting such as thirty seconds between spins in a virtual game. Input device 330 or output device 320, for example, via a display (not shown) may likewise represent a denomination indicator for cash or other wager via physical item.

FIGS. 2A and 2B, as attached, consistent with FIG. 1 hereof, is a sample, being only a sample of numerous and other related variations of game and house rules (as mentioned in the above), all of which are within the scope of the present invention. A straight of two or more consecutive numbers may be evaluated by processor 300 or the accumulation of eights in consecutive spins such as 8, 18 and 28 or other chosen number. Frankly, the inventor chose eights because Straights and Eights rhyme. The side game of Straights and Eights may contain on the straights side certain aspects of poker and on the eights side a combination of eights between 1 and 36 comprising 8, 18 and 28 specifically.

Each player may make two wagers by placing chips (cash or credit) in the form, for example, of physical items in a betting, for example, a circular location 1, 2, 3, 4, 5 and 6 seen in FIG. 1 for receiving the form of physical items or electronically in a virtual or displayed circular location. In an electronic game, the player may be given a unique number and that unique number displayed to the player on an intelligent device such as a cell phone. If a game is played for fun, the players may accumulate a score equivalent to their game play and wagering. As described above, a betting structure for allocating a place bet between consecutive spins that are active simultaneously may be played until their wager is lost or a given spin value results in a win in straights or eights. Players with single wagers may be allowed to bet the house or machine limit on each consecutive spin if they meet a certain value of credit in physical items. A player evaluates their spin value and makes a decision of what to do. They may continue to a next spin value because there have been consecutive spin values or values forming gaps or a win due to at least two eights. The croupier or machine using artificial intelligence may then pick up any loss and place those physical items in a house kiosk for reuse. All such wagers described above may be in the form of one or more or fractional physical items if the casino rules permit. When all wagers are set for a given spin either in roulette or straights and eights, the croupier may cause a spin value to be displayed based on a known reader circuit. The croupier (or machine) evaluates consecutive spin values using artificial intelligence if the croupier is an intelligent device and decides when wagers may be placed before and during a given spin and sets the dealer or machine roulette or straights and eights way of playing or both ways of playing.

While various aspects of the present invention have been described above, it should be understood that they have been presented by way of example and not limitation. It will be apparent to persons skilled in the relevant art(s) that various changes in form and detail can be made therein without departing from the spirit and scope of the present invention. Thus, the present invention should not be limited by any of the above described exemplary aspects, but should be defined only in accordance with the following claims and their equivalents.

In addition, it should be understood that the three figures, which highlight the structure, methodology, functionality and advantages of the present invention, are presented for example purposes only. The present invention is sufficiently flexible and configurable, such that it may be implemented in ways other than that shown in the accompanying figures.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present invention in any way.

What we claim is:

1. Apparatus for playing a side game of roulette including a computer processor for executing instructions regarding side game game play including an instruction for displaying a virtual two to five consecutive spin values comprising spin values between one and thirty-six and zero or zero and double zero alternative spin values, an output device responsive to receipt, validation and identification of a player monetary value wager in physical items, each physical item having a monetary value in fractional or whole currency values, an input device for receiving said monetary value wager to establish a credit value in physical items, the computer processor for validating said player monetary value wager as a credit toward side game play in physical items and then for receiving a player command to the special purpose computer processor for selecting a wager in the form of two consecutive spins of a roulette wheel that a straight of two consecutive spin values or two values comprising an eight are received in a virtual or real roulette pocket, the input device for further receiving a further command of a croupier for determining a period of time for placing a bet comprising one of a real time clock input device to the computer processor and a predetermined signal received by an input device from a croupier, a memory coupled to the special purpose computer processor for storing a plurality of spin values for roulette greater than or equal to two spin values, the special purpose computer processor for evaluating consecutive spin values to determine if one of straights and eights have occurred; and
the output device for displaying a player's virtual wagers, the special purpose computer processor determining which of the first, second and third spin values of the player has a chance of being a straight or an eight and causing said game apparatus to provide a payout in physical items via the output device between the machine and the player based on the occurrence of one of a straight and an eight.

2. The apparatus of claim 1 further comprising a communications interface for communicating with a remote special purpose computer system, the remote special purpose computer system making the determination of a straight and an eight via artificial intelligence of a machine, the machine selected first and second spin values for comparison with the straight and the eight.

3. The apparatus of claim 1 further comprising the output device, responsive to a comparison of virtual player wagers and spin values by the special purpose processor, rewarding a player with one of a monetary reward in one or more physical items or fractional physical items.

4. The apparatus of claim 1 further comprising the special purpose computer processor calculating a loss of a wager after at least two consecutive spin values are stored in memory and neither a straight nor an eight have occurred.

5. A computer program product for implementing non-transitory instruction logic for a side game to roulette for use in constructing a computer processor for playing a side game of straights and eights where a straight comprises two consecutive spin values and an eight comprises one of the roulette spin values of 8, 18 and 28, the computer program product comprising first computer logic for causing a display of a first spin value upon receipt and validation of a player monetary value in physical items via an input device and establishing an identified credit in physical items toward game play as a wager, second computer logic for receiving a player wager and comparison against winning straights and eights from any remaining roulette spins without a wager loss, third computer logic for selecting, assembling and storing a virtual roulette wheel plurality of spin values using artificial intelligence and including evaluating a first two consecutive spins for consecutive spin values or two spin values leaving a gap value or the presence of first and second spin values including an eight; fourth computer logic for determining a winner of a reward in physical items between the machine comprising the special purpose computer processor and the player for first or and second spin values by rules of poker for straights and eights wherein an eight is one of eight, eighteen and twenty-eight spin value.

6. The computer program product of claim 5 wherein said first computer logic causes display of a three consecutive spin values and the spin values represent eight, eighteen and twenty-eight in any order and responsive to the special purpose processor having said first, second, third and fourth computer logic, the special purpose processor paying out approximately 300 to 1 odds based on the number of physical items of a wager.

8. A method of playing a side game of straights and eights with roulette wherein each player has a unique identification and the method comprises receiving a player wager via an input device in one or more physical items or fractional physical items, validating receipt and establishment of credit toward game play in physical items, receiving a wager on receiving one of a straight comprising consecutive spin values from the player or eights determined by consecutive spin values comprising an eight, a machine comprising a special purpose processor programmed for playing the side game of straights and eights including evaluating whether consecutive spin values result in a straight or first and second spin values including an eight, and
causing the machine to provide a payout in physical units to the player when the two of the first and second consecutive spins comprises one of a straight and an eight.
